(19) United States
(12) Patent Application Publication
(10) Pub. No.: US 2003/0161989 A1
(43) Pub. Date: Aug. 28, 2003

(54) Lightweight fiber-reinforced thermoplastic resin molding

(75) Inventor: Satoru Funakoshi, Kyoto (JP)

Correspondence Address: Kendrew H. Colton, FITCH, EVEN, TABIN & FLANNERY, Suite 401L, 1801 K Street, N.W., Washington, DC, 20006-1201, US

(73) Assignee: Sumitomo Chemical Company, Limited, Osaka (JP)

(21) Appl. No.: 10/348,606

(22) Filed: Jan. 22, 2003

Related U.S. Application Data
(63) Continuation-in-part of application No. 09/891,164, filed on Jun. 26, 2001.

(30) Foreign Application Priority Data
Jun. 30, 2000 (JP) 2000-198910

(51) Int. Cl. B32B 3/00; B32B 5/22

(52) U.S. Cl. 428/71; 428/317.9

(57) ABSTRACT

The present invention provides a fiber-reinforced thermoplastic molding containing reinforcing fibers whose average fiber length is at 1 mm or more and including, across a section inwardly the thickness direction, a skin layer having almost no voids, a foamed or expanded layer with a percentage of void of 10-50 vol % and a layer with a percentage of void greater than that of the foamed or expanded layer in which the reinforcing fibers are intertwined in a complicated manner so as to establish a fiber network in which fibers are fixed to each other with the thermoplastic resin in the vicinity of their points of contact. This fiber-reinforced thermoplastic molding has a high percentage of voids and is lightweight while also having excellent rigidity against bending.

### RELATED APPLICATIONS

This application is a continuation in part of U.S. application Ser. No. 09/891,164, filed Jun. 26, 2001, the complete disclosure of which is incorporated herein by reference.

### BACKGROUND OF THE INVENTION

1. Field of the Invention

The present invention relates to lightweight fiber-reinforced thermoplastic resin moldings including a skin layer, a foamed or expanded layer and a fiber network layer.

2. Description of the Related Art

As a molding that is reinforced with reinforcing fibers and has voids formed therein, lightweight fiber-reinforced thermoplastic resin moldings which have a dense skin layer having almost no voids and a core layer having voids are well known. Such generally known lightweight fiber-reinforced thermoplastic resin moldings do not necessarily have satisfactory bending rigidities at high expansion ratios. Furthermore, for example, JP-A-7-16933 discloses a fiber-reinforced thermoplastic resin molding comprising a fiber-reinforced thermoplastic resin containing 20-70% by weight of reinforcing fibers 5-25 mm long, the molding having a foamed core layer and skin layers disposed on both surfaces of the core layer, the skin layers containing reinforcing fibers oriented almost in parallel to their surfaces, wherein 20% by weight or more of the reinforcing fibers contained in the core layer are oriented almost perpendicular to the skin layers.

However, such a fiber-reinforced thermoplastic resin molding is problematic in that since the molding is composed only of dense skin layers and a foamed core layer, if the skin layers are thin, strength of the skin layers will reduce or the skin layers will be broken or buckled due to bending load applied. Such a molding has another problem that thickening the skin layers for solving the above problems results in the increase of weight of the molding.

### SUMMARY OF THE INVENTION

In view of these facts, the present inventors sought a lightweight fiber-reinforced thermoplastic resin molding that has a high expansion ratio, a high bending rigidity even if a skin layer is thin. As a result of their investigations, the present inventors reached the present invention.

Accordingly, the present invention provides a lightweight fiber-reinforced thermoplastic molding containing reinforcing fibers whose average fiber length is 1 mm or more. Inwardly, across a section of the molding in its thickness direction, the molding includes a skin layer having almost no voids, a foamed or expanded layer with a percentage of voids of 10-50 vol % and next a further layer with a percentage of voids greater than that of the foamed or expanded layer in which reinforcing fibers are entangled, e.g. intertwined, with each other and are fixed to each other with the thermoplastic resin in the vicinity of their contacts.

In other embodiments, reinforcing fibers can also be included in or extend into the skin layer, the foamed or expanded layer or both. It will be appreciated that reinforcing fibers in one of the three layers can extend into one or both adjoining layers.

Throughout this specification and the claims which follow, unless the context requires otherwise, the word “comprise,” and variations such as “comprises” and “comprising,” will be understood to imply the inclusion of a stated integer or step or group of integers or steps but not the exclusion of any other integer or step or group of integers or steps.

### BRIEF DESCRIPTION OF THE DRAWINGS

FIG. 1 includes sectional schematic views of lightweight fiber-reinforced thermoplastic resin moldings of the present invention, with FIG. 1(a) showing the case where there is no skin material on the surface and FIG. 1(b) showing the case where a skin material is laminated.

FIG. 2 is a schematic sectional view of a mold to be used for the production of a lightweight fiber-reinforced thermoplastic resin molding of the present invention.

FIG. 3 illustrates a process for the production of a lightweight fiber-reinforced thermoplastic resin molding of the present invention by a schematic sectional view of a mold.

FIG. 4 illustrates a process for the production of a lightweight fiber-reinforced thermoplastic resin molding of the present invention by a schematic sectional view of a mold.

FIG. 5 illustrates a process for the production of a lightweight fiber-reinforced thermoplastic resin molding of the present invention by a schematic sectional view of a mold.

FIG. 6 illustrates a process for the production of a lightweight fiber-reinforced thermoplastic resin molding of the present invention by a schematic sectional view of a mold.

FIG. 7 illustrates a process for the production of a lightweight fiber-reinforced thermoplastic resin molding of the present invention by a schematic sectional view of a mold.

FIG. 8 illustrates a process for the production of a lightweight fiber-reinforced thermoplastic resin molding of the present invention by a schematic sectional view of a mold.

FIG. 9 illustrates a process for the production of a lightweight fiber-reinforced thermoplastic resin molding of the present invention by a schematic sectional view of a mold.

FIG. 10 illustrates a process for the production of a lightweight fiber-reinforced thermoplastic resin molding of the present invention by a schematic sectional view of a mold.

FIG. 11 illustrates a process for the production of a lightweight fiber-reinforced thermoplastic resin molding of the present invention by a schematic sectional view of a mold.

FIG. 12 illustrates a process for the production of a lightweight fiber-reinforced thermoplastic resin molding of the present invention by a schematic sectional view of a mold.

FIG. 13 illustrates a process for the production of a lightweight fiber-reinforced thermoplastic resin molding of the present invention by a schematic sectional view of a mold.

### DETAILED DESCRIPTION OF THE PREFERRED EMBODIMENTS

The further applicability and utility of the present invention will become apparent from the detailed description. However, it should be understood that the detailed description and any specific examples, while possibly indicating preferred embodiments of the invention, are given by way of illustration only, since various changes and modifications within the spirit and scope of the invention will become apparent to those skilled in the art from this detailed description.

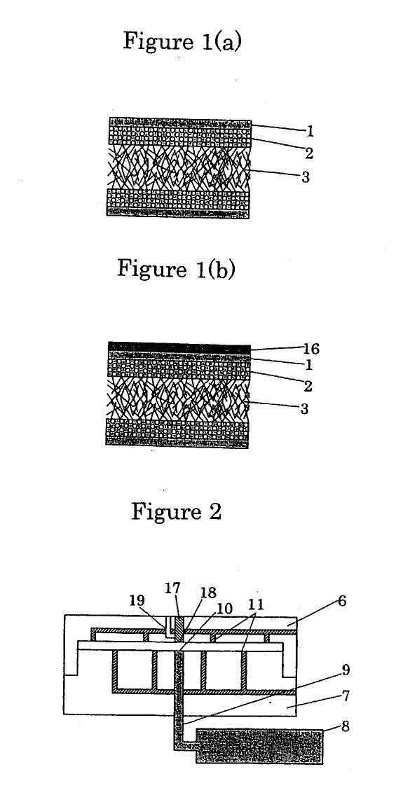

The lightweight fiber-reinforced thermoplastic resin molding comprises at least one skin layer (1) having almost no voids, a foamed or expanded layer (2) with a percentage of voids of 10-50 vol %, and a layer (3) with a percentage of voids greater than that of the foamed or expanded layer in which the reinforcing fibers are entangled, e.g., intertwined, with each other to form a fiber network in which the fibers are fixed to each other with a thermoplastic resin in the vicinity of the points of fiber-to-fiber contact. In the following description, layer (3) may sometimes be referred to as a network layer. An illustrative partial sectional view across a thickness direction of a present molding is shown in FIG. 1 (FIG. 1(a)).

As illustrated in FIG. 1(b), the molding can have additional layer(s). As shown in FIG. 1(b), the molding may have a structure where a skin material (16) is disposed on a skin layer (1), as needed.

In a given layer (1), (2) or (3), a thermoplastic resin will be present. In any layer containing fibers, such fibers (reinforcing fibers) should have an average fiber length is about 1 mm or more. In the case of reinforcing fibers having-an average fiber length less than 1 mm, sufficient rigidity against bending may not be obtained. In general, suitable average fiber lengths can be, for instance, about 1 mm to about 10 mm, although an average length of about 2 mm to about 10 mm may be preferred.

Furthermore, good bending rigidity can be obtained in the molding by ensuring there is a sufficient content of the reinforcing fibers in the thermoplastic resin in a particular layer, especially layer (3). The content of the reinforcing fibers in the thermoplastic resin is usually about 10-80% by weight, and preferably is about 20-50% by weight with respect to the total amount of the thermoplastic resin in all of layers (1), (2) and (3).

Various conventionally known reinforcing fibers can be used in the present molding. Exemplary reinforcing fibers include glass fibers, carbon fibers and alumina fibers. Glass fibers are widely used and are quite popular.

Any thermoplastic resin is suitable as long as it can be used in extrusion forming, injection molding, press molding and the like. For example, general thermoplastic resins such as polyethylenes, polypropylenes, polystyrenes, acrylonitrile-styrene-butadiene copolymers, polyvinyl chlorides, polyamides, polycarbonates and polyethylene terephthalates, mixtures thereof, or polymer alloys using these thermoplastic resins may be mentioned. The term “thermoplastic resin” used in the present invention includes all of these species. It will be appreciated that for ease of manufacture, it may be preferred to form each of the layers (1), (2) and (3) in the present lightweight fiber-reinforced thermoplastic resin molding from the same material, such as the same thermoplastic resin.

Moreover, a thermoplastic resin may, as needed, contain fillers such as talc. Various additives conventionally used, such as pigments, lubricants, antistatic agents and stabilizers, may optionally be incorporated in a thermoplastic resin selected for a molding of the present invention.

The greater the adhesion of the reinforcing fibers to the thermoplastic resin, the firmer the linkage of the fibers themselves through the matrix resin and the greater the strength of an expanded molding. Therefore, in the case, for example, of the combination of a matrix resin (such as a polypropylene-based resin) and glass fibers (reinforcing fibers), we have found applying surface treatment to the glass fibers or incorporating a modifier to the polypropylene-based resin improves the fiber-to-resin-to-fiber adhesion, which also improves the strength of the expanded molding.

In the molding comprising such materials, a skin layer (1), a foamed or expanded layer (2) and a layer (3) are generally laminated in this order when viewed inwardly from a surface of the molding. As will be appreciated, the layers are firmly integrated one another. Layer (3) can be deemed a structural support layer and can be considered as fiber-supported support layer in which the fibers are entangled in a complex, random pattern(s), which can be characterized as a reinforcing fiber network.

In such a molding, the skin layer (1), which is located outermost of the three layers, is superior in tensile strength in the plane direction and contributes to the enhancement of bending rigidity of the molding. The foamed or expanded layer (2) prevents the skin layer (1) from bending along its plane direction and from breaking or buckling. A layer (3) plays a role in reducing the weight of the whole molding and also in ensuring adequate bulk and thickness for a molding.

Furthermore, the average percentage of void of the above three layers in the molding of the present invention is preferably 50 vol % or more, and more preferably 60 vol % or more with respect to weight reduction.

A skin layer (1) may be located in or on a surface of a molding. A molding may have a skin layer (1) on, in or at only one of its surfaces. However, it is preferred to have a molding with two surfaces and to have a skin layer (1) on, in or at both surfaces to enhance the resistance to bending, that is improve the rigidity of the molding.

The thickness of a skin layer (1) can greatly affect whether or not the molding is reduced in weight. In general, as the skin layer becomes thicker, the strength of the molding is improved but the weight increases, whereas as a skihn layer (1) becomes thinner, the weight of the molding may be reduced. However as the skin layer becomes thinner and it becomes easier to break. This can reduce the overall strength of the molding. Accordingly, it is preferred that the ratio of the quantity (amount) of the resin in the skin layer to the quantity (amount) of the resin contained in the whole of the above-mentioned three layers is about 5-30% by weight and the skin layer is about 0.1-2 mm in thickness.

A skin layer (1) is generally comprised of a material that enables the skin layer to possess high tensile strength. For this purpose, it is necessary for the skin layer to contain reinforcing fibers having an average fiber length of 1 mm or more and to have approximately no voids or only slight voids therein. Here, the condition “slight voids” means “almost no voids,” which are expressions meaning at least essentially void free.

Generally, the strength of a thermoplastic resin can be greatly improved by incorporating reinforcing fibers. In particular, incorporating reinforcing fibers in a thermoplastic resin can significantly improve tensile strength or bending strength of a product made using such resin. Tensile and bending strength tend to be greater as the length of the reinforcing fibers increases.

For this reason, a skin layer (1) with superior strength can be obtained when it includes reinforcing fibers of at least about 1 mm in length. In general, the average fiber length can be 1 mm to about 10 mm, although an average length of about 2 mm to about 10 mm may be preferred.

Furthermore, generally there is a tendency that when a volume proportion of voids (percentage of void or voids) in a thermoplastic resin becomes greater, the strength of the thermoplastic resin deteriorates. Accordingly, it becomes necessary to reduce a percentage of void in the skin layer so that there may be approximately no voids or only slight voids in the skin layer. The objective is to prevent buckling due to compression stress.

Moreover, the reinforcing fibers in the skin layer are preferably oriented approximately in parallel to the plane of the molding to prevent the skin layer from breaking or buckling.

The orientation of the reinforcing fibers with respect to the plane direction of the molding is not particularly limited and may be optionally determined according to bending rigidity, etc. required for a desired molding. However, for example, if particularly high rigidity is required in a single direction, it is preferred that many of the reinforcing fibers are oriented in such single direction. If rigidity is not required to be directional, the reinforcing fibers are preferably oriented at random.

The foamed or expanded layer (2) having 10-50 vol % of voids in the thermoplastic resin containing reinforcing fibers is firmly integrated with the skin layer (1) and functions to prevent the skin layer from breaking caused by an applied tensile stress or from buckling caused by an applied compressive stress. In particular, the foamed or expanded layer (2) plays a great role in the reinforcement of the skin layer against its buckling.

In general, the thickness of the foamed or expanded layer (2) and a ratio of the quantity of the resin contained in it to the quantity (amount) of resin contained in the three layers (1), (2) and (3), are optionally determined depending upon the desired thickness or rigidity against bending required for a particular molding. For instance, the thickness of a foamed or expanded layer (2) is usually about 0.2-80 mm and the ratio of the quantity of the resin contained in the foamed or expanded layer (2) to the resin in layers (1), (2) and (3) is preferably about 10-60% by weight.

Since such a foamed or expanded layer (2) contains voids, this layer is thicker, by approximately a thickness corresponding to the voids, than a resin layer that contains no voids and is composed of the same volume of the same resin. Moreover, the foamed or expanded layer (2) has a lower tensile strength in comparison to the skin layer due to the voids, but the layer has improved resistance to bending. Therefore, lamination of a skin layer (1) and a foamed or expanded layer (2) can prevent the skin layer from buckling.

Here, to achieve the aforementioned effect sufficiently, the percentage of void in the foamed or expanded layer (2) is important. As the percentage of void becomes lower, the resistance to bending becomes greater but it becomes difficult to reduce weight. On the other hand, a higher percentage of void is effective in weight reduction but resistance to bending is sacrificed, i.e. deteriorates. Accordingly, the percentage of void in the foamed or expanded layer (2) is preferably about 10-50 vol %, and more particularly can be about 30-45 vol %.

The denser the voids in such a foamed or expanded layer, the better the voids exhibit their characteristics. For the same percentage of voids, a foamed or expanded layer with smaller voids may have superior mechanical properties, such as resistance against bending, in comparison to a like foamed or expanded layer with larger sized voids.

There is a tendency that the longer are the reinforcing fibers in the foamed or expanded layer (2), the greater the resistance to bending. Accordingly, it is important that the reinforcing fibers have an average fiber length of 1 mm or more. In general, the average fiber length can be 1 mm to about 10 mm, although an average length of about 2 mm to about 10 mm may be preferred.

To enhance resistance to bending, it is desirable that the reinforcing fibers contained in a foamed or expanded layer (2) are oriented at angles of 0-45 degrees with respect to the plane direction of the molding. Angles greater than 0 degrees may tend to increase the resistance to bending in the plane direction of the molding.

Furthermore, the direction of orientation of the reinforcing fibers is not particularly limited and may be determined depending upon bending rigidity which a desired molding is required to have. For example, if particularly high rigidity is required in a single direction, it is only required to cause most reinforcing fibers to be oriented in this direction. That is, orienting fibers approximately parallel to a direction generally results in greater high rigidity in that direction. If “directional” rigidity is not required, the reinforcing fibers can be oriented at random.

The reinforcing fibers in the foamed or expanded layer (2) and those in the skin layer (1) are not required to be kept as separate reinforcements, i.e are not necessarily exclusive of one another. For instance, reinforcing fibers may extend from one layer through to another of the layers in the molding. Thus, in the case when at least a portion of the fibers extend between a foamed or expanded layer (2) to a skin layer (1), both layers are integrated together more firmly.

The layer (3) increases the thickness of the whole molding and plays a role in improving the rigidity on account of its constitution and thickness. As mentioned, in a layer (3) the reinforcing fibers are intertwined and fixed in fiber-to-resin-to-fiber (or a fiber bound with resin to fiber) relationship at points where fibers contact each other. The fibers are fixed to each other, bound or “bonded” to each other, by a thermoplastic resin in the vicinity of their fiber-to-fiber contacts. The complicated intertwining may be said to result in a fiber network.

A layer (3) can be therefore be considered a support layer. In general, a layer (3) should have a percentage of void greater than that of a foamed or expanded layer (2). This helps reduce the overall weight of the molding. In general, a layer (3) has a percentage of void of about 50-90 vol %.

It is important for the reinforcing fibers in a layer (3) to have an average fiber length of 1 mm or more. If the average fiber length is less than 1 mm, reinforcing fibers are not intertwined in a sufficiently complicated manner whereby the strength of the layer (3) decreases, and particularly, resistance to compression in the thickness direction decreases, as a result, a layer (3) with a desirable combination of good characteristics may not be formed.

Furthermore, there is a tendency that the closer the reinforcing fibers in the layer (3) are oriented to the molding thickness direction, the greater is the resistance to compression stress in the thickness direction. However, when the orientation direction of the reinforcing fibers becomes normal (perpendicular or almost perpendicular) to the thickness direction, the resistance to slip between surfaces deteriorates between layer(2) and (3), and as a result, rigidity against bending of the molding is reduced. For this reason, it is desirable that many of the reinforcing fibers in the layer (3) are oriented with angles of, for example, 10-70 degrees, preferably 30-70 degrees with respect to the thickness direction of the molding.

It is not necessary that all of the reinforcing fibers forming a network in layer (3) be confined exclusively to that layer. A portion of the fibers or a part of the fibers may extend from the layer (3) into the foamed or expanded layer (2), or, in some cases, may extend from the layer (3) through a foamed or expanded layer (2) through to a skin layer (1).

It will be appreciated that the average fiber lengths of the fibers in differing layers may preferably be approximately the same due to practical considerations in the manufacturing process. This may obtain particularly when the same material, e.g. the same molten resin composition, is used to form each of the layers (1)-(3).

Although each layer constituting the lightweight fiber-reinforced thermoplastic resin molding of the present invention has been explained above, the molding of the present invention usually has a structure where, as shown in FIG. 1, a core is comprised of a layer (3), foamed or expanded layers (2) sandwich the layer (3) and skin layers (1) sandwich the foamed or expanded layers (2), and the layers are integrally laminated to one another. One or more other optional layers such as a skin material may be further laminated on one or both surfaces of the molding.

Next, a process for the production of such a lightweight fiber-reinforced thermoplastic resin molding is illustrated, with reference to the Figures.

FIG. 2 illustrates the outline in a cross sectional view of an exemplary mold that can be used in a process for producing a molding of the present invention.

This mold comprises a pair of a male die (7) and a female die (6). In general, one of the dies is associated with a press device and is movable, while the other die is fixed. The mold can be opened and closed vertically or horizontally. In FIG. 2, the male die is fixed, the female die is movable, and the mold can be opened and closed vertically.

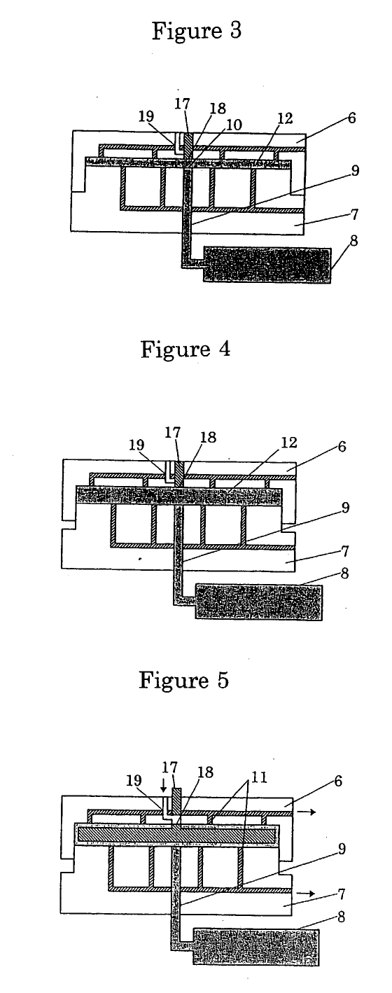

Although a method to supply a molten thermoplastic resin containing reinforcing fibers (which may henceforth be referred to simply as a molten resin) to a mold cavity is optional, one such method that may be selected involves a resin supply opening (10), which is connected to a resin supply device (8) via a resin supply passage (9) dug in the mold. A resin supply opening (10) can be provided in a molding surface of one or both of the female and male dies. In FIG. 3, the opening is provided in the molding surface of the male die. A molten resin can be supplied through the resin supply opening to a mold cavity defined between the male and female dies.

In this case, it is also possible to design the mold so that a freely-operatable valve is provided in the resin supply passage in the vicinity of the resin supply opening and the supply of a molten resin accumulated in the resin supply device such as an injection unit and the stop thereof can freely be controlled The mold may have a suction opening (11), which opens to the mold cavity, provided to a molding surface of one or both of the female and male dies, and may be designed so that an expanded molding is attracted onto the molding surface, such as by applying a vacuum (suction, reduced pressure, by evacuation) through the opening.

The suction opening (11) is connected to an evacuating device, which is not shown, such as a vacuum pump via a suction path and the suction path may be equipped with a valve capable of freely controlling suction, including stopping the suction action, and it may also be equipped with a control mechanism to adjust the amount of suction force, as may be needed.

The suction opening (11) opens in a molding surface of the mold and is preferably configured or designed to prevent molten resin from being sucked into the opening. For instance, a suction opening (1) may be comprised of fine pores. Moreover, it may also be a crack in the juncture of parts constituting the mold, generally called the parting line. Alternatively, the mold may be constituted in part or in approximately whole of porous metal having gas permeability.

Moreover, the mold may have a structure where one or both of the female and male dies have a portion that interconnects the inside and the outside (the atmosphere) of the cavity and the air is introduced to the cavity through that portion.

The interconnecting portion may be an opening hole (18) formed in the molding surface of the mold and also may be a pin-like part (not shown) having an opening hole. Alternatively, the periphery portion of the mold cavity may be utilized as the interconnecting portion.

For example, in the case where an opening hole (18) is provided in the molding surface of the mold, the opening hole (18) is opened to the atmosphere via an air channel (19) provided in the mold. To the opening hole (18), a valve (17) for opening and closing the opening hole, which can freely control the opening and closure of the opening hole, may be provided. Moreover, a control mechanism for adjusting the size of the opening or of an opening hole may also be provided, as needed.

In use, a molten resin (12) is charged to a mold cavity defined between the female and male dies (FIG. 4). In the production of a molding of present invention, it is important to supply a molten thermoplastic resin containing reinforcing fibers whose average fiber length is maintained at 1 mm or more to a mold cavity.

The term “average fiber length of reinforcing fibers” refers to the length of the fibers contained in the thermoplastic resin in the molding. Therefore, the term “reinforcing fibers whose average length is maintained at 1 mm or more” (or comparable expression herein) means reinforcing fibers having length such that the reinforcing fibers in the thermoplastic resin of the molding obtained have an average length of 1 mm or more. As the “average fiber length,” a weight average fiber length, which is a general index, is used.

The “average fiber length of reinforcing fibers” used in the following description has the same meaning as that described above.

One method for supplying such a molten thermoplastic resin containing suitable reinforcing fibers to a mold cavity may be comprise supplying a molten resin to a cavity wherein the molten resin is obtained by melt-kneading reinforcing fibers having an average fiber length of 3 mm or more and thermoplastic resin granules or pellets in, for example, an injection unit having an in-line screw. Another method may comprise supplying a molten resin to a mold cavity wherein the molten resin was (is) obtained by melt-kneading a pre-formed thermoplastic resin material containing reinforcing fibers having an average fiber length of 3 mm or more, for example, long-fiber-reinforced thermoplastic resin pellets.

In the latter method, it may be preferred to use the long-fiber-reinforced thermoplastic resin pellets obtained by impregnating a glass roving with a molten thermoplastic resin, cooling and solidifying the resultant impregnated roving, and then cutting the cooled resin-impregnated roving into suitable length(s), for example, about 3-25 mm to form pellets. Such long-fiber-reinforced thermoplastic resin pellets may be used alone or in a mixture with thermoplastic resin pellets, which is a means for the adjusting the reinforcing fiber content. As will be appreciated, such long-fiber reinforced thermoplastic resin pellets may be used after being mixed with other pellets that are comprised of the same or different thermoplastic resin as in the long-fiber-reinforced resin pellets. Furthermore, the pellets may contain a necessary amount of foaming agent.

The temperature of the molten resin to be used varies depending on the type of heat and molding conditions, and on the type of a skin material to be used when a skin material is used, and is set to an optimum temperature. For example, when a glass fiber-reinforced resin containing a polypropylene-based resin as a matrix is used, the temperature of the resin is about 170-300° C., and is preferably about 200-280° C.

A charge of a molten resin (12) to the mold cavity may be accomplished, for instance, by either injection charging or introducing the resin and closing the female and male dies. The way of charging the molten resin may optionally be selected depending on the desired product form.

The former method by injection charging may be exemplified by a method in which the supply of a molten resin is commenced with both dies positioned so that the cavity clearance is less than the thickness of a molding before expansion (FIG. 3.) The mold is opened concurrently with the supply of the molten resin, whereby the molten resin is charged in the cavity so that the cavity clearance becomes, at the same time when the supply of the molten resin is completed, equal to the thickness of the molding before expansion (FIG. 4), and also by a method in which the molten resin is supplied with both dies positioned so that the cavity clearance equal to the thickness of the molding before expansion is defined, whereby the molten resin is supplied and charged in the cavity.

In the former case by injection charging, the cavity clearance at the time molten resin supply commences is usually not less than 5% by volume and less than 100% by volume, preferably not less than 30% by volume and not greater than 70% by volume, based on the volume of a predetermined quantity of molten resin before expansion. At the time when the supply of the molten resin is commenced, the dies may be positioned so that the cavity clearance is less than the thickness of the molding before expansion.

When the supply of the molten resin is commenced in such a state, the movable die retreats so that the cavity clearance is enlarged as the supply of the molten resin proceeds. Upon completing the supply of the pre-determined quantity of the molten resin, the volume of the molten resin supplied becomes approximately equal to the capacity of the cavity.

In such a step, the enlargement of the cavity clearance may be controlled by the mechanical retreat of the die by using a press unit or the like associated with the mold. The cavity clearance may alternatively be enlarged by utilizing the supply pressure of the molten resin to be supplied. In any case, the enlargement is preferably controlled so that the pressure applied to the resin is or becomes about 1-50 MPa.

In the enlargement of the cavity clearance, care must be taken that the cavity volume does not exceed the volume of the molten resin supplied. However, no special problem arises even when the cavity volume exceeds the volume of the molten resin supplied, if it occurs instantaneously or in a very short time.

Moreover, in the case of the injection charging, a supply of a molten resin is commenced with both dies positioned so that the cavity clearance is equal to the thickness of a molding before expansion, and this only requires that the cavity clearance of the mold is maintained at the thickness of the molding before expansion from the beginning to the completion of the supply of the molten resin, as in the ordinary injection molding.

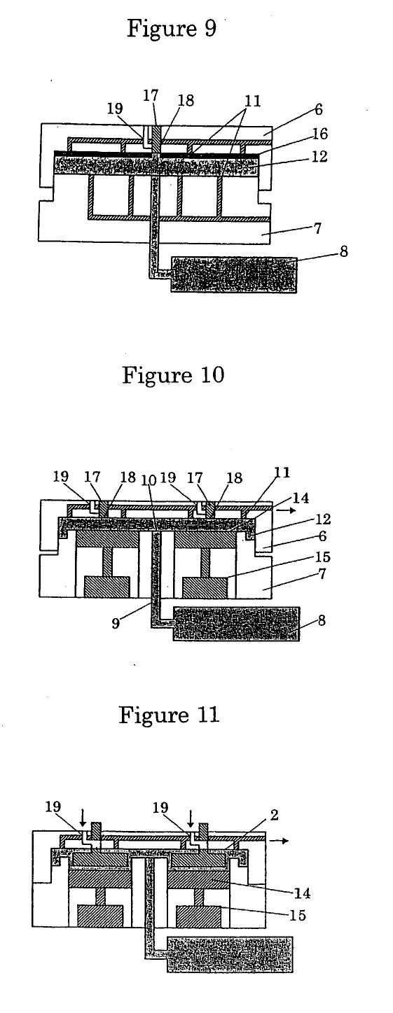

As mentioned above, molten resin can be charged in the cavity accompanied by clamping of the mold dies. Among the possible methods is on one in which a predetermined quantity of molten resin is supplied into a mold cavity defined between opened mold dies so that the cavity clearance is not smaller than the thickness of the molding before expansion (FIG. 8) and the dies are, after or at the same time as the molten resin supply is completed, closed so that the cavity clearance coincides with the thickness of the molding before expansion, whereby the molten resin is charged (FIG. 9). In another method, the supply of the molten resin is commenced as the mold dies are being clamped. The supply of the molten resin and the clamping of the mold are conducted in parallel so that the cavity clearance becomes equal to the thickness of the molding before expansion just as or after the completion of the supply of the molten resin.

In addition, FIGS. 8 and 9 show an example in the case where the skin layer (16) is laminated. When no skin layer is laminated, it is not necessary to provide a skin layer between the mold in advance and the supply of the molten resin into between the male and female dies opened may be commenced.

Of these methods, the narrower the cavity clearance at the time of supplying the molten resin, the better the surface appearance of the moldings obtained when injection charging in which the supply of the molten resin is commenced with the dies positioned so as to define a cavity clearance less than the thickness of the molding before expansion. However, if the cavity clearance is too narrow, the damage to the reinforcing fibers in the molten resin tends to be great. Therefore, the cavity clearance is properly determined depending on the thickness, size and shape of the molding.

On the other hand, when molten resin is charged by the clamping of the dies, since the pressure applied to the molten resin in the mold cavity to be supplied becomes lower. As a consequence, damage to the reinforcing fibers in the molten resin may be minimized. This may prevent the reduction of expandability of the molten resin or result in a product having superior strength because undamaged fibers may mean avoiding a reduction in strength the molding.

Considering these facts, in general, the method by injection charging is useful when the external appearance of expanded moldings is important and the method by charging by the clamping of the mold is useful when considerations of expandability of the molten resin or strength of the expanded moldings are important.

The molten resin charged in the mold cavity by such methods is in a state where it involves approximately no voids or, in some cases, only slight voids.

A skin layer (1) is caused to form in such a state. Since the temperature of the mold is generally set to be lower than that of the molten resin, the molten resin begins to solidify from its surface portion in contact with a molding surface of the mold and a skin layer having approximately no voids or only slight voids is formed during an optional cooling time. (FIG. 5) The cooling time has a great effect on the formation of a skin layer. The longer the cooling time, the easier the formation of a skin layer and the thicker a skin layer becomes.

The cooling time, that is, the time interval between the completion of the charging of the molten resin in the cavity and the opening of the mold in the next step may vary depending on various conditions such as the mold temperature, the temperature of the molten resin supplied and the type of the resin. But, generally it may be about 0.2-20 seconds.

After the formation of the skin layer, the mold cavity is slightly opened in the thickness direction of the molding, thereby forming a foamed or expanded layer with a percentage of void of 10-50 vol %.

Accordingly, a mold opening stroke in this operation is required to be a stroke such that the percentage of void of the unsolidified other than the skin layer falls within the above range.

The foamed or expanded layer is cooled in this state.

Furthermore, as for the “foamed or expanded layer” used herein, in principle, when expansion caused by spring-back of the reinforcing fibers following the opening of the mold is observed relatively clearly, the corresponding layer is, for convenience, called an expanded layer. On the other hand, as often observed in the case where a percentage of void is relatively low and a foaming agent is utilized rather than expansion caused by spring-back, when many voids formed through foaming following the mold opening are observed, the corresponding layer is, for convenience, called a foamed layer. However, it is not necessary to strictly differentiate between the expanded layer and the foamed layer. These terms are used to be distinguished from another layer, the fiber network layer (3).

When a predetermined foamed or expanded layer has been formed (not shown), the cavity clearance of the mold is further opened until it becomes a thickness of the desired final molding.

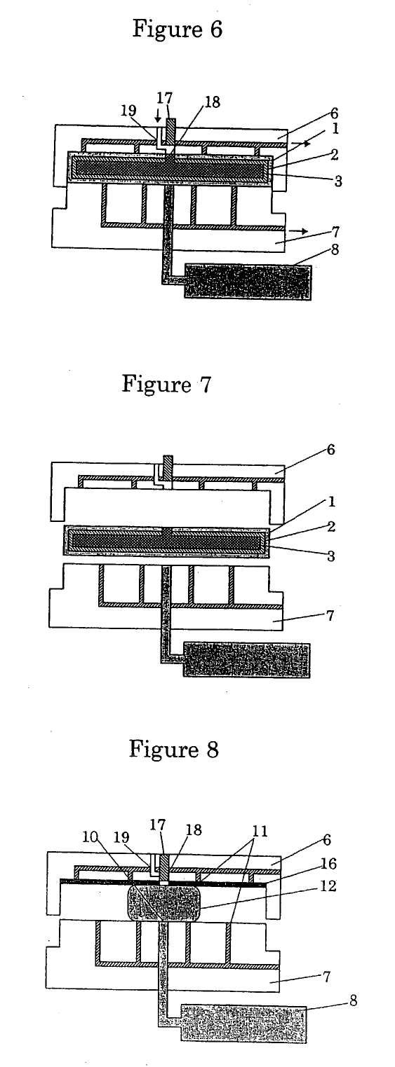

In this opening step, the internal unsolidified resin is further expanded than the foamed or expanded layer, thereby increasing voids and forming a fiber network layer in due course (FIG. 6).

Here, for orienting many of the reinforcing fibers in the fiber network layer with angles, for example, of 10-70 degrees with respect to the thickness direction of the molding, it is important to properly adjust the speed of mold opening during the opening step. For example, the opening speed may be from 0.1 mm/sec to 3 mm/sec, and desirably from 0.3 mm/sec to 2 mm/sec.

The molding is cooled under the conditions where the thickness of the final molding is maintained, whereby the molten resin is solidified. The mold is thereafter opened and the desired molding is removed (FIG. 7).

Furthermore, in the operation of mold opening after the formation of the foamed or expanded layer, it is also possible to open the cavity clearance of the mold so that it may become greater than the thickness of the final molding, followed by recompressing the molten resin by closing the mold until the cavity clearance becomes equal to the thickness of the final molding while the central portion of the resin is still in molten state.

In this case, it is possible to cause the molten resin supplied and the molding surface of the mold to more closely come into contact and also possible to reproduce the shape of the mold more faithfully.

Furthermore, in such a method, if the mold is opened in the thickness direction of the molding while the skin layer is attracted onto the molding surface of the mold by evacuating, in the course of or after the formation of the skin layer, through a suction opening (11) provided in the mold, moldings having higher percentages of void may be obtained.

At this time, the mold is opened while taking the air into the molding by interconnecting the mold cavity with the atmosphere. Due to that, the pressure inside the molding becomes negative and the inhibition of the restoring force of the reinforcing fibers is prevented, whereby a molding expanded with a high expansion ratio may be obtained.

FIGS. 5 and 6 simultaneously show states that the skin layer is attracted onto the molding surface of the mold by evacuating through a suction opening opened in a molding surface of the mold and that the atmosphere is taken into the cavity.

During the operation of mold opening, it is desirable to control the mold opening speed, the mold opening stroke and the like with a press device mounted to the mold or a mold opening device installed in the mold, such as a hydraulic cylinder.

In the above-described method, by using a mold having a structure where a part of the mold can be moved partly, a lightweight fiber-reinforced thermoplastic resin molding locally having an expanded portion may be produced.

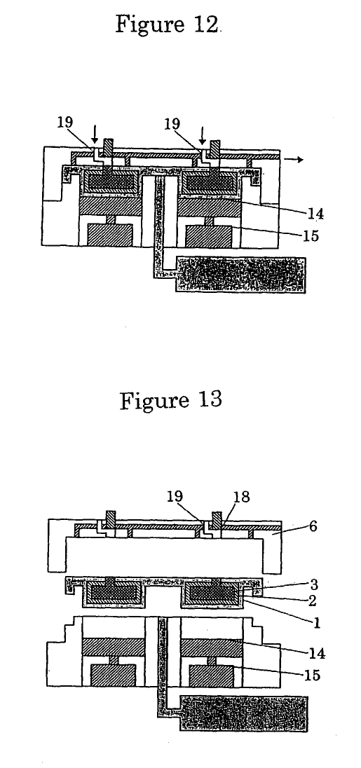

By using a mold, as shown in FIG. 10, in which a part of the mold is composed of a movable-molding-surface-forming member, for example a slide core system using a slide core (14), and a part of the molding surface of the mold can be locally and independently moved in the mold opening-and-closing direction through the movement of the slide core by a molding-surface-moving device such as a hydraulic cylinder (15) and adjusting the level of the molding surface of the slide core (14) to that of the molding surface of the mold, followed by charging a molten resin into the cavity by the aforementioned method (FIG. 10), followed by locally opening the mold by retreating the slide core after the formation of the skin layer as shown in FIGS. 11-13, thereby forming a foamed or expanded layer, followed by locally opening the mold by retreating the slide core in order to expand a central part of the unsolidified portion, thereby a lightweight fiber-reinforced thermoplastic resin molding may be obtained in which a skin layer, a foamed or expanded layer and a beam-supported structure layer are comprised in the portion where the slide core was located.

Moreover, in the case where what is required is a skin material-integrated lightweight fiber-reinforced thermoplastic resin molding, a part or the whole of the surface of which is covered with a skin material (16) laminated, the following operations may be conducted in the aforementioned method; placing, in advance, the skin material (16) on a molding surface of the mold so as to cover a part or the whole of the molding surface, supplying and charging a molten resin to between the skin material and the molding surface on which no skin material is placed according to the method mentioned above, and then opening the mold with evacuation as needed.

At this time, depending on the skin material, as shown in FIG. 8 and FIG. 9, the method in which the molten resin is supplied between the opened mold and charged into the cavity by the clamping of the dies is sometimes preferable.

As a skin material to be used in such a method, general skin materials may be employed such as sheets or films of various kinds of thermoplastic resins, foamed sheets of thermoplastic resins, non-woven fabrics, fabrics and combinations of these materials.

Furthermore, when a skin material is laminate, a skin layer may be difficult to be formed in the molten resin's surface on which the skin material is laminated. In such a case, it is also possible to use a skin material impermeable to gas and cause the skin material stuck with the molten resin to be attracted onto the molding surface of the mold by regarding the skin material as a skin layer.

The lightweight fiber-reinforced thermoplastic resin molding of the present invention may be produced by the above-described method, but, in some cases, only insufficient expansion occurs and insufficient voids are formed depending upon the type of the thermoplastic resin or reinforcing fibers to be used or the content of the reinforcing fibers. In such cases, expansion may be facilitated and the formation of voids may be compensated by use of a foaming agent.

The amount of the foaming agent used here may be a slight amount. As little as 0.01-5% by weight relative to the resin components contained in the raw material, the thermoplastic resin containing reinforcing fibers, may be used.

Moreover, the formation of voids may also be compensated by injection of a compressed gas into the molten resin through a gas injection opening or a resin supply opening provided in the molding surface of the mold.

Those skilled in the art may refer to the description of a molded article, including fibers, and a fiber network in U.S. Pat. No. 5,843,568 for additional guidance, for which purpose the description is incorporated herein. It will, however, it will be appreciated that in a molding according to the present invention, the internal structure differs in that it comprises a skin layer that can be integral to a foamed or expanded layer, which in turn can be against a layer (3) that comprises a network of fibers bound to one another with a thermoplastic resin at their points of contact and which has a percentage of void(s) differing from an adjoining layer (2). This novel internal architecture is described further in the Figures.

The lightweight fiber-reinforced thermoplastic resin molding of the present invention is described in Japanese application 2000-198910, filed Jun. 30, 2000, the disclosure of which is incorporated herein by reference. The fiber-reinforced thermoplastic molding has a high percentage of void(s), is lightweight and has excellent rigidity. Therefore, it can be widely used in a variety of applications such as various interior parts or structural parts for houses as well as vehicles, including cars and trucks.

The foregoing detailed description of embodiments of the present invention has been provided for the purposes of illustration and description and to explain the principles of the present invention and its practical applications to enable others skilled in the art. It is not intended to be exhaustive or to limit the claimed invention to the precise embodiments disclosed.

What is claimed is:

1. A lightweight fiber-reinforced thermoplastic molding containing reinforcing fibers whose average fiber length is at 1 mm or more and containing thermoplastic resin, said molding comprised of a structure across a section of its thickness of (a) an at least essentially void-free skin layer; (b) a foamed or expanded layer with a percentage of voids of 10-50 vol %; and (c) a layer having s percentage of voids greater than that of the foamed or expanded layer (b), wherein said layer (c)comprises a network of intertwined reinforcing fibers in which fibers in contact with one another are fixed to each other with the thermoplastic resin in the vicinity of their contacts.

2. The lightweight fiber-reinforced thermoplastic molding according to claim 1, wherein the skin layer (a), the foamed or expanded layer (b) and the layer (c) are integrated in this order from the surface of the molding.

3. The lightweight fiber-reinforced thermoplastic molding according to claim 1, wherein the resin in the skin layer comprises 5-30% by weight of the total amount of the resins present in the skin layer (a), the foamed or expanded layer (b) and layer (c); and an average percentage of voids in the whole of the skin layer (a), the foamed or expanded layer (b) and the layer (c) is at least 50 vol %.

4. The lightweight fiber-reinforced thermoplastic molding according to claim 1, wherein said molding further comprises a skin material laminated on at least a part of a surface of the molding.
